(19) United States
(12) Patent Application Publication
(10) Pub. No.: US 2005/0233299 A1
(43) Pub. Date: Oct. 20, 2005

(54) Method for preserving organs for transplantation with a HGF-containing solution

(76) Inventors: Yoshiki Sawa, Nishinomiya (JP); Hikaru Matsuda, Ashiya (JP); Toshikazu Nakamura, Kyoto (JP); Shinya Mizuno, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 10/967,247

(22) Filed: Oct. 19, 2004

(30) Foreign Application Priority Data
Apr. 19, 2004 (JP) 123257/2004

(51) Int. Cl. A01N 1/02

(52) U.S. Cl. 435/1.3

(57) ABSTRACT

A method of preserving a harvested organ, a harvested organ tissue or a part thereof for a long time, which comprises perfusing and/or immersing the harvested organ with a solution containing HGF having a temperature of 0 to 6° C., and which method is capable of maintaining harvested organs for transplantation in a high physiological state and preventing ischemia/reperfusion injury of the organs transplanted.

### BACKGROUND OF THE INVENTION

1. Field of the Invention

The present invention relates to a method of preserving a harvested organ, a harvested organ tissue or a part thereof, which comprises bringing various organs, organ tissues or parts thereof from living or dead bodies into contact with a solution containing hepatocyte growth factor (referred to as HGF) having a temperature of 0 to 6° C. More particularly, the invention relates to a method of preserving or perfusing harvested organs, organ tissues or parts thereof for surgical transplantation, which can prevent tissue degeneration under cold preservation of the organs harvested from donors before transplantation, and prevent organ failure and/or immunological rejection after transplantation of the organs. Further, the present invention relates to a solution used for preserving a harvested organ, a harvested organ tissue or a part thereof, comprising HGF of a temperature of 0 to 6° C. in an amount of 0.1 μg/mL to 1 mg/mL.

2. Description of the Prior Art

Organ transplantation grafts harvested from donors are preserved under cold conditions at 0 to 6° C., under which conditions tissues are shown to minimize (but not completely block) histolysis, for attenuating tissue degeneration even after blood flow is arrested. The organ grafts are usually stored for several minutes to a few hours before being transplanted into recipients, and during such cold storage, the tissue degeneration gradually develops. Tissue injury occurring during cold storage causes organ failure and/or immunological rejection during or after transplantation of the organs. For this reason, if storage conditions, such as storage temperature, a preservation or perfusion solution and the like, are not properly selected or if too much time elapses before transplantation, the transplanted organs may undergo parenchymal or functional injury when the warm blood flow penetrates into the transplanted graft organs after the vessel anastomosis (at reperfusion). Therefore, the capability of maintaining the organs for transplantation as they are at harvesting is extremely important in transplantation. For preserving the harvested organs for transplantation in physiological conditions, methods of preserving the harvested organs in a preservation solution under cold conditions has been developed. As preservation solutions, Euro-Collins solution and UW solution are known (see Squifflet, J. P. et al., Transplantation Proceeding, volume 13, 1981, p. 693 and Wahlberg, J. A. et al., Transplantation Proceeding, volume 43, 1988, pp. 5 to 8, for example). However, organs preserved in these preservation solutions have not functioned satisfactory. A trial of adding insulin-like growth factor (IGF-1), which has the activity of protecting organs, in a preservation solution for maintaining the functions of organs has been made. However, an animal experiment has not resulted in remarkable achievement (see Petrinec, D. et al., Surgery, volume 120 (issue 2), 1996, pp. 221 to 225).

HGF is a protein which was found with growth of hepatocytes as an indicator, but it has been made clear by subsequent studies that HGF also has the action of growing a wide variety of epithelial cells and some kinds of mesenchymal cells in addition to hepatocytes. It is also known that, in addition to its cell growth activity, HGF shows various activities on cell migration, cell morphogenesis, cell death suppression, neovascularization and the like (see Matsumoto, K. et al., Kidney International, volume 59, 2001, pp. 2023 to 2038, for example).

HGF is known to be cytoprotective toward parenchymal epithelial cells from oxidant stresses-related injuries in an in vitro study (see, WO 96/32960), which may be critically involved in ischemia-reperfusion after organ transplantation. However, this prior art publication does not discloses an ex vivo organ preservation solution or an organ perfusion solution containing HGF for preserving harvested organs at cold temperatures.

### SUMMARY OF THE INVENTION

An object of the present invention is to provide a method of preserving a harvested organ, which comprises perfusing and/or immersing the harvested organ, organ tissues or parts thereof with a solution containing HGF having a temperature of 0 to 6° C., and which method allows such organs for transplantation to be preserved under cold conditions even for a relatively long time, for example, up to 10 hours and can prevent storage injury, organ failure and/or acute and chronic immunological rejections after surgery.

It should be noted that, in the present invention, the preservation of organs means maintaining physiological and functional activities of the organs at harvesting as much as possible, and the solution for cold preservation of organs means a solution for the purpose of maintaining the above-mentioned conditions of the organs. The perfusion of organs means flowing the solution through the inside of organs, and the solution for perfusion of organs means a solution which flows through the inside of organs, thereby discharging blood and the like existing in the organs therefrom for washing the inside of the organs with maintaining the above-mentioned conditions of the organs as much as possible.

After earnest efforts to attain the above-described object, the inventors of the present invention have found that when isolated organs for transplantation are perfused with a solution containing HGF and then immersed for preservation in the solution under cold conditions during the storage or transportation for the aiming transplantation of the organ into patient waiting operation, the organs can be preserved in extremely physiological conditions during an ischemic time period. The present invention has been accomplished based upon these findings.

The invention relates to:

(1) A method for preserving a harvested organ, a harvested organ tissue or a part thereof, which comprises bringing various organs, organ tissues or parts thereof from living or dead bodies into contact with a solution containing hepatocyte growth factor (referred to as HGF) having a temperature of 0 to 6° C.

(2) A method for preserving a harvested organ, a harvested organ tissue or a part thereof according to claim 1, which comprises perfusing and/or immersing the harvested organ, organ tissue or part thereof, with a solution containing HGF having a temperature of 0 to 6° C.

(3) The method according to the above (1) or (2), wherein the solution contains HGF in an amount of 0.1 μg/mL to 1 mg/mL.

(4) The method according to the above (1) or (2), wherein concentration of HGF for perfusion is 50 μg/mL to 500 μg/mL and concentration of HGF for immersion is 0.1 μg/mL to 50 μg/mL.

(5) The method according to the above (1) or (2), wherein concentration of HGF for perfusion is 1 μg/mL to 10000 μg/mL and concentration of HGF for immersion is 0.01 μg/mL to 1000 μg/mL.

(6) The method according to the above (1) or (2), wherein the organ is selected from hearts, livers, kidneys, lungs, pancreases and small intestines, and the organ tissue is selected from skins and corneas.

(7) A method for preserving a harvested organ, harvested tissue or a part thereof for a relatively long time up to 10 hours, which comprises perfusing and/or immersing above-mentioned harvested organ, organ tissue or a part thereof, with a solution containing HGF having a temperature of 0 to 6° C.

(8) A method for preventing a harvested organ, harvested organ tissues or a part thereof from storage injury occurring during the storage of the organs before transplantation or organ failure occurring after transplantation, which comprises perfusing and/or immersing a harvested organ, harvested tissue or parts thereof, with a solution containing HGF having a temperature of 0 to 6° C.

(9) A solution used for preserving a harvested organ, a harvested organ tissue or a part thereof, comprising HGF of a temperature of 0 to 6° C. in an amount of 0.1 μg/mL to 1 mg/mL.

(10) A solution used for perfusing and/or immersing a harvested organ, a harvested organ tissue or a part there, comprising HGF of a temperature of 0 to 6° C. in an amount of 0.1 μg/mL to 1 mg/mL.

(11) A solution used for perfusing and/or immersing a harvested organ, a harvested organ tissue or a part there, comprising HGF of a temperature of 0 to 6° C., wherein the concentration of HGF for perfusion is 50 μg/mL to 500 μg/mL and that of HGF for immersion is 0.1 μg/mL to 50 μg/mL.

(12) A solution used for perfusing and/or immersing a harvested organ, a harvested organ tissue or a part there, comprising HGF of a temperature of 0 to 6° C., wherein the concentration of HGF for perfusion is 1 μg/mL to 10000 μg/mL and that of HGF for immersion is 0.01 μg/mL to 1000 μg/mL.

(13) The solution according to any one of the above (9) to (12), wherein the organ is selected from the group consisting of hearts, livers, kidneys, lungs, pancreases, small intestines, skins and corneas.

The solution for preservation or perfusion of organs used in the present invention can be a liquid for preserving or perfusing organs before transplantation. Harvested organs which are preserved and/or perfused with the solution for preservation or perfusion of organs can be maintained in highly functionally and morphologically physiological conditions in accordance with the present invention. When the harvested organs, harvested organ tissues or parts thereof are preserved or perfused with the solution containing HGF, it is possible to attenuate the progress of tissue degeneration of above-mentioned organs before transplantation due to cooling and is also possible to effectively minimize tissue injuries occurring after transplantation.

The present invention using a solution for perfusion of organs can prevent injury which might occur at and after perfusion of the harvested organs, organ tissues or parts thereof, especially ischemic and immunological injuries.

Further, the method of the present invention using a solution for preservation of organs, organ tissues or parts thereof can prevent storage injury and ischemic injury of the harvested organs, organ tissues or parts thereof due to cooling stress which might occur during a long-term cold preservation, i.e. storage of such organs.

Because the method of the present invention using a solution for preservation of organs, organ tissues or parts thereof allows the long-term cold preservation of the harvested organs, organ tissues or parts thereof, it is possible to extend the time period from the excision of the organs, organ tissues or parts thereof from donors to the transplantation thereof into recipients. Since that leads to the extension of the duration of transporting the harvested organs, organ tissues or parts thereof by transportation means such as airplanes, helicopters, automobiles, trains, etc, it is possible to extend a geographical area for recipients to receive the donation of the organs, organ tissues or parts thereof.

### BRIEF DESCRIPTION OF THE DRAWING

FIG. 1 is a graph showing a recovery ratio of systolic pressure of left ventricles of excised hearts of rats. The mark ** in the figure denotes existence of a significant difference with respect to the recovery rate of eight hour stored hearts (HGF-) at a significance level of 1% or less;

FIG. 2 is a graph showing a recovery ratio of the maximum power dp/dt of the left ventricles of the excised hearts of rats. The mark ** in the figure denotes existence of a significant difference with respect to the recovery rate of eight hour stored hearts (HGF-) at a significance level of 1% or less;

FIG. 3 is a graph showing the activity of CPK, an enzyme leaked from cardiac muscles, in coronary blood vessels of the excised hearts of rats. The mark * in the figure denotes existence of a significant difference at a significance level of 5% or less; and

FIG. 4 is a graph showing an apoptosis positive ratio of cardiac muscle cells of the excised hearts of rats. The mark * in the figure denotes existence of a significant difference at a significance level of 5% or less.

### DETAILED DESCRIPTION OF THE INVENTION

HGF used in the present invention is a known substance. HGF prepared by various processes, if purified enough to be used as a medical agent, can be used in the present invention. Regarding production processes of HGF, for example, natural HGF can be obtained by cultivating primary culture cells or cells of an established cell line which produce HGF, isolating HGF from culture supernatant or the like and purifying the isolated HGF. Alternatively, recombinant HGF can also be obtained by a genetic engineering method of integrating a gene encoding HGF into an appropriate vector, inserting the vector into proper host cells for transformation thereof and collecting the target recombinant HGF from culture supernatant of the transformed cells (see Japanese Unexamined Patent Publication No.: 5-111382, Biochem. Biophys. Res. Commun. volume 163, 1989, p.967 and the like, for example). The above-mentioned host cells are not particularly limited, and various kinds of host cells conventionally used in the genetic engineering methods, such as Escherichia coli, yeast, animal cells or the like may be used. The obtained HGF, so long as it has substantially the same action as natural HGF, may include substitution, deletion, addition and/or insertion of one or more (e.g., several) amino acids in the amino acid sequence thereof. Similarly, HGF may include substitution, deletion and/or addition of sugar chains. Here “the deletion, substitution, addition or insertion of one or more of amino acids” in the amino acid sequence means that amino acids of the amino acid sequence in a number (one to several amino acids), such as can occur naturally or by known technical methods such as genetic engineering methods, site-specific mutating methods and the like, may be deleted, substituted, added and/or inserted into the amino acid sequence. Also, “HGF including substitution, deletion and/or addition of sugar chains” means, for example, (1) a glycosylation-deficient HGF which is obtained by treating a natural glycosylated HGF with an enzyme to remove sugar chains, (2) HGF of which amino acid sequence is mutated at a glycosylation site, resulting in no glycosylation, or (3) HGF of which amino acid sequence is mutated in such a manner that glycosylation occurs at a site different from the natural glycosylation site.

Further, HGF also includes a protein having an at least 60% or more homology, preferably 80% or more homology, more preferably 90% or more homology, still more preferably 95% or more homology to the amino acid sequence of HGF and also having a differentiation-inducing activity on bone marrow cells to endothelial precursor cells or endothelial cells. The above-mentioned “homology” between amino acid sequences generally means that the amino acid residues constituting the amino acid sequences agree to each other if the primary structures of proteins are compared.

HGF used in the present invention may have a carboxylate (—COO—), amide (—CONH₂) or ester (—COOR) at its C terminal in place of a carboxyl group (—COOH) so long as it has substantially the same action or function as natural HGF. Here, as R in the ester, optionally substituted lower alkyl groups (e.g., methyl, ethyl, propyl, cyclopentyl, benzyl, phenethyl, etc.), aryl groups (e.g., phenyl, α-naphthyl, etc.), pivaloyloxymethyl groups, which are generally used as oral esters, and the like may be mentioned. HGF usable in the present invention may include HGF in which an amino group of a methionine residue at the N-terminal is protected by a protective group (e.g., an acyl group such as formyl, acetyl, etc.), HGF in which a glutamyl group produced by cutting an N-terminal side in vivo has changed to a pyroglutamic acid and the like. The above-mentioned HGFs are all known.

According to a preferred mode of the present invention, the solution for preservation of organs (also referred to simply as a preservation solution hereinafter) and the solution for perfusion of organs (also referred to simply as a perfusion solution hereinafter) can be prepared, for example, by dissolving HGF in a physiologically acceptable buffer or isotonic solution such as physiological saline, phosphate buffered saline (containing the following ingredients in 1,000 mL: 0.0425 g of potassium dihydrogen phosphate; 8.5 g of sodium chloride), citrate buffer solution or Ringer's solution (containing the following ingredients in 500 mL: 4.3 g of sodium chloride; 0.15 g of potassium chloride; 0.165 g of calcium chloride dehydrate), Krebs-Henseleit buffer solution (118.0 mM of sodium chloride; 4.7 mM of potassium chloride; 2.5 mM of calcium chloride; 1.2 mM of potassium dihydrogen phosphate; 1.2 mM of magnesium sulfate, 25.0 mM of sodium hydrogen carbonate; 10.0 mM of glucose) or the like. Preferably, the solution used in the present invention is a preservation and/or perfusion solution which is prepared by blending a required amount of HGF in Euro-Collins solution (containing the following ingredients in 100 mL of the finally prepared solution: 740 mg of dipotassium hydrogen phosphate; 205 mg of potassium dihydrogen phosphate; 112 mg of potassium chloride; 84 mg of sodium hydrogen carbonate; 3.5 g of glucose), UW solution (containing the following ingredients in 1,000 mL of the finally prepared solution: 50 g of pentafraction; 35.83 g of lactobionic acid; 3.4 g of potassium dihydrogen phosphate; 1.23 g of magnesium sulfate; 17.83 g of raffinose; 1.34 g of adenosine; 0.136 g of allopurinol; 0.922 g of reduced glutathione; an adequate amount of potassium hydroxide; sodium hydroxide for adjustment to pH 7.4) or the like. Euro-Collins solution and UW solution are conventionally used clinically as a preservation and/or perfusion solution for organ transplantation.

The HGF concentrations in the preservation or perfusion solution used in the present invention should be determined specifically depending upon the way of using the preservation or perfusion solution, the kind, size, condition and preservation time of an organ to be preserved and the like, and is not particularly limited. For example, however, in a liquid agent state, the HGF levels may be about 0.1 μg/mL to 1 mg/mL, preferably about 1 to 500 μg/mL, more preferably about 1 to 100 μg/mL.

Further, other compounds reported to be effective for organ preservation and perfusion may be blended in the preservation or perfusion solution used in the present invention. Such compounds include glycine, α-ketoglutamic acid, hydroxyethyl starch, lecithinized superoxide dismutase and the like, for example. The concentration of the compounds is not particularly limited. However, in the case of glycine and α-ketoglutamic acid, the concentration may generally be within the range of about 0.1 to 10 mM, preferably about 2 mM, and in the case of hydroxyethyl starch, the concentration may generally be within the range of 3 to 7.5% (w/w), preferably about 5% (w/w) (see Mazaki, Y. et al., Today's Transplantation, volume 7 (issue 2), 1994, pp. 171 to 174). In the case of lecithinized superoxide dismutase, in a liquid agent state, the concentration may generally be about 5 μg/mL to 50 mg/mL (15 to 150,000 U/mL), preferably about 50 μg/mL (see Japanese Unexamined Patent Publication No. 2002-60301).

Generally, the harvested organ for transplantation may be immersed in the above prevention solution and preserved until transplanted at about 0 to 6° C., preferably, a container with the organ therein being placed on ice. The preservation time may vary depending upon the kind and condition of the organ, but typically within about ten hours, preferably within eight hours, more preferably within six hours, still more preferably within four hours. Preferably the harvested organ for transplantation may be perfused with the above perfusion solution and then immersed in the above solution for preservation. Perfusion may be carried out by inserting a catheter in an artery (for example, a coronary artery in the case of a heart, a renal artery in the case of a kidney, a hepatic artery in the case of a liver or the like) and infusing the perfusion solution through the catheter for washing the inside of the organ. The preservation solution and the perfusion solution may have the same or different HGF concentration. For example, the HGF concentration in the perfusion solution may be about 1 to 10000 μg/mL, preferably 10 to 1000 μg/mL, more preferably 50 to 500 μg/mL, further more preferably 50 to 200 μg/mL, most preferably 50 to 100 μg/mL. After perfused, the organ may be immersed and preserved in the preservation solution having preferably a lower HGF concentration than the perfusion solution, for example, about 0.01 to 1000 μg/mL, preferably 0.1 to 50 μg/mL, more preferably 0.1 to 20 μg/mL, most preferably 1 to 20 μg/mL. In another mode, the organ for transplantation may be perfused with the above perfusion solution and then immersed and preserved in a known organ preservation solution not containing HGF such as Euro-Collins solution. Furthermore, the above perfusion solution may be used for finally washing or perfusing the organ just before transplantation. Preferably, the perfusion solution used in the present invention is cooled to about 0 to 6° C. before used in any of the above-described cases.

The above-described perfusion and preservation solutions may contain the same or different buffers as a base.

The use of the perfusion solution and the preservation solution as a perfusion solution and a preservation solution as described above allows the harvested organs for transplantation to be preserved in highly physiological conditions until transplantation and can prevent post-ischemia reperfusion injury in the transplanted organs. The kind of organs for transplantation is not particularly limited, but for example, hearts, livers, kidneys, lungs, pancreases, small intestines and the like, and parts thereof are organs which can be suitably preserved or perfused with the above preservation or perfusion solution. Hearts cold-preserved or perfused with the above preservation or perfusion solution can present an improved recovery ratio of power, and in the case of kidneys, post-ischemia reperfusion injury such as acute kidney failure and the like, and parts thereof can be remarkably prevented. Further, examples of the organ tissues are skins, corneas and the like, and parts thereof, and these organ tissues can be also preserved under cold condition for a relatively long time, e.g. up to ten hours, in the same manner as in the above-mentioned organs to be transplanted.

### EXAMPLES

The present invention is now described in further detail by way of examples and a test example, but the invention should not be construed to be limited thereto.

In the following description, percent % denotes percent by mass, except where specifically noted.

### Example 1

Organ preservation/perfusion solution

| | |
|---|---|
| HGF | 5 mg (5 μg/mL) |
| Sodium chloride | 9 g |
| Purified water | in a proper amount |
| | (1,000 mL in total) |

The above-mentioned ingredients were dissolved in purified water to obtain 1,000 mL of the solution.

### Example 2

Organ preservation/perfusion solution

| | |
|---|---|
| HGF | 30 mg (30 μg/mL) |
| Potassium dihydrogen phosphate | 0.0425 g |
| Sodium chloride | 8.5 g |
| Purified water | in a proper amount |
| | (1,000 mL in total) |

The above-mentioned ingredients were dissolved in purified water to obtain 1,000 mL of the solution.

### Example 3

Organ preservation/perfusion solution

| | |
|---|---|
| HGF | 500 mg (50 μg/mL) |
| Citric acid monohydrate | 18.1 g |
| Sodium chloride | 32.2 g |
| Purified water | in a proper amount |
| | (10,000 mL in total) |

Citric acid monohydrate and sodium chloride were dissolved in purified water to obtain 1,000 mL of solution. At use, the solution was diluted 10 times and adjusted to pH 5.9 with a citric acid solution or a sodium hydroxide solution, and then HGF was dissolved.

### Example 4

Organ preservation/perfusion solution

| | |
|---|---|
| HGF | 100 mg (200 μg/mL) |
| Sodium chloride | 4.3 g |
| Potassium chloride | 0.15 g |
| Calcium chloride dihydrate | 0.165 g |
| Purified water | in a proper amount |
| | (500 mL in total) |

The above-mentioned ingredients were dissolved in purified water to obtain 500 mL of solution, which was adjusted to pH 7.2 with use of hydrochloric acid or a sodium hydroxide solution.

### Example 5

Organ preservation/perfusion solution

| | |
|---|---|
| HGF | 100 mg (100 μg/mL) |
| Sodium chloride | 6.9 g |
| Potassium chloride | 0.35 g |
| Calcium chloride dihydrate | 0.37 g |
| Potassium dihydrogen phosphate | 0.15 g |
| Magnesium sulfate | 0.14 g |
| Sodium hydrogen carbonate | 2.1 g |
| Glucose | 1.8 g |
| Purified water | in a proper amount |
| | (1,000 mL in total) |

The above-mentioned ingredients were dissolved in about 800 mL of purified water. The obtained solution was adjusted to pH 7.4 with hydrochloric acid or a sodium hydroxide solution, and the total amount was increased to 1,000 mL with purified water.

### Example 6

Organ preservation/perfusion solution

| | |
|---|---|
| HGF | 100 mg (100 μg/mL) |
| Dipotassium hydrogen phosphate | 7.4 g |
| Potassium dihydrogen phosphate | 2.05 g |
| Potassium chloride | 1.12 g |
| Sodium hydrogen carbonate | 0.84 g |
| Glucose | 35 g |
| Purified water | in a proper amount |
| | (1,000 mL in total) |

The above-mentioned ingredients were dissolved in about 80 mL of purified water, and the total amount was increased to 1,000 mL with purified water.

### Example 7

Organ preservation/perfusion solution

| | |
|---|---|
| HGF | 4 mg (4 μg/mL) |
| Dipotassium hydrogen phosphate | 7.4 g |
| Potassium dihydrogen phosphate | 2.05 g |
| Potassium chloride | 1.12 g |
| Sodium hydrogen carbonate | 0.84 g |
| Glucose | 35 g |
| Purified water | in a proper amount |
| | (1,000 mL in total) |

The above-mentioned ingredients were dissolved in about 80 mL of purified water, and the total amount was increased to 1,000 mL with purified water.

### Example 8

Organ preservation/perfusion solution

| | |
|---|---|
| HGF | 50 mg (50 μg/mL) |
| Pentafraction | 50 g |
| Lactobionic acid | 35.83 g |
| Potassium dihydrogen phosphate | 3.4 g |
| Magnesium sulfate | 1.23 g |
| Raffinose | 17.83 g |
| Glucose | 3.5 g |
| Adenosine | 1.34 g |
| Allopurinol | 0.136 g |
| Reduced glutathione | 0.922 g |
| Purified water | in a proper amount |
| | (1,000 mL in total) |

The above-mentioned ingredients were dissolved in about 800 mL of purified water. The obtained solution was adjusted to pH 7.4 with a sodium hydroxide solution. The total amount was increased to 1,000 mL with purified water.

### TEST EXAMPLE

Ex vivo Cardiac Function of Excised Hearts

Male SD rats (weight: approx. 300 g) were thoracically incised to excised hearts under general anesthesia with pentobarbital sodium (50 mg/kg intraperitoneally administered). The excised hearts were immersed in Krebs-Henseleit buffer (37° C.) for about 20 minutes in order to stabilize ex vivo movement of the hearts. During this immersion, catheters were inserted and set in the left ventricles of the hearts. Subsequently, the hearts were arrested by infusing a glucose injection containing a high potassium solution (a heart stop solution containing 20 mEq/L of potassium ions) into coronary vessels of the excised hearts. Immediately after the hearts were arrested, the hearts were perfused by infusing a large amount of the organ preservation/perfusion solution of Example 6 (approx. 0 to 6° C.) via the above-mentioned catheters to discharge the heart stop solution from the hearts. The hearts were placed in a container containing Euro-Collins solution, which was allowed to stand still onto ice for cold-preserving the hearts for eight hours. As control, hearts were preserved for four, six and eight hours with use of Euro-Collins solution without the use of the above organ preservation/perfusion solution of Example 6.

The preserved hearts were washed with Krebs-Henseleit buffer at 37° C. to remove the above-mentioned preservation/perfusion solution. The hearts were connected to a Langendorff perfuser (Isolated Heart Size 1 (murine heart), produced by HSE-Harvard) to resume heart strokes. The myocardial systolic pressure and maximum power dp/dt of the left ventricles were recorded using a polygraph (Nihon Kohden Medical Device Company, Japan). For evaluation, ratios were calculated with respect to the myocardial systolic pressure and maximum power dp/dt of hearts which were connected to the Langendorff perfuser. The activity of an enzyme leaked from cardiac muscles (CPK) in coronary vessels was determined. The CPK activity was determined using a CPK Test Wako Kit (Wako Pure Chemical Industries Ltd., Japan) which utilized the creatinine phosphate substrate/tetrazolium method. Remaining tissues of the hearts were rapidly frozen by embedding them in an embedding agent for freeze sectioning. Then the frozen tissues were sectioned at 4-8 μm with a microtome for freeze sectioning, apoptosis positive cells were detected using an Apop Tag Apoptosis in situ Detection Kit (Intergen Co. Pardige, N.Y.) which utilized the TUNEL method.

### RESULTS

(1) Myocardial Systolic Pressure

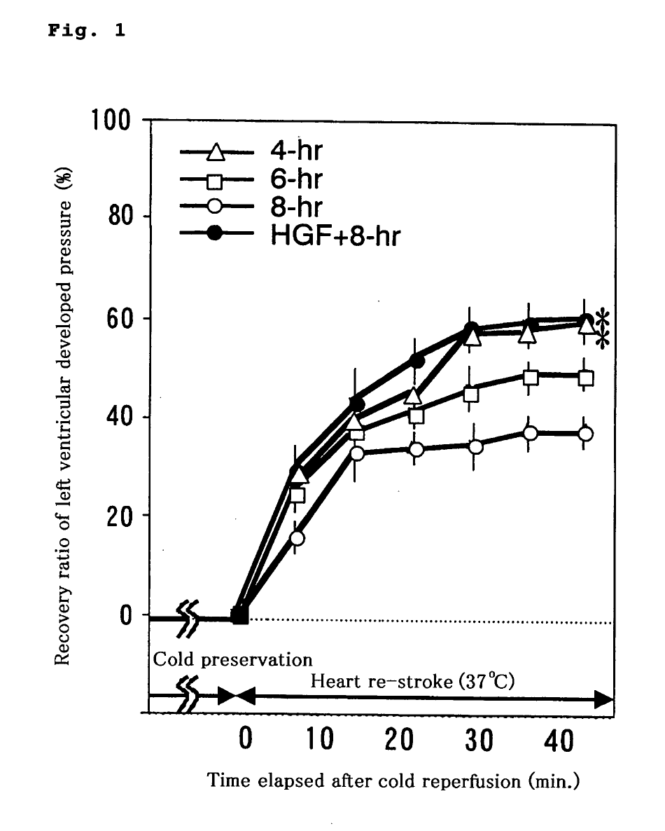

FIG. 1 shows the recovery ratio of the left ventricle systolic pressure. The systolic pressure after four hour and six hour cold preservation in Euro-Collins solution recovered about 60% and about 50%, respectively, within one hour after the resumption of heart strokes. The systolic pressure after eight-hour cold preservation in Euro-Collins solution recovered about 40% one hour after the resumption of heart strokes. Meanwhile, in the case where the hearts were perfused with the organ preservation/perfusion solution of Example 6 and preserved in cold Euro-Collins solution for eight hours, the systolic pressure recovered about 60%, which confirmed significant improvement by HGF.

(2) Maximum Power dp/dt

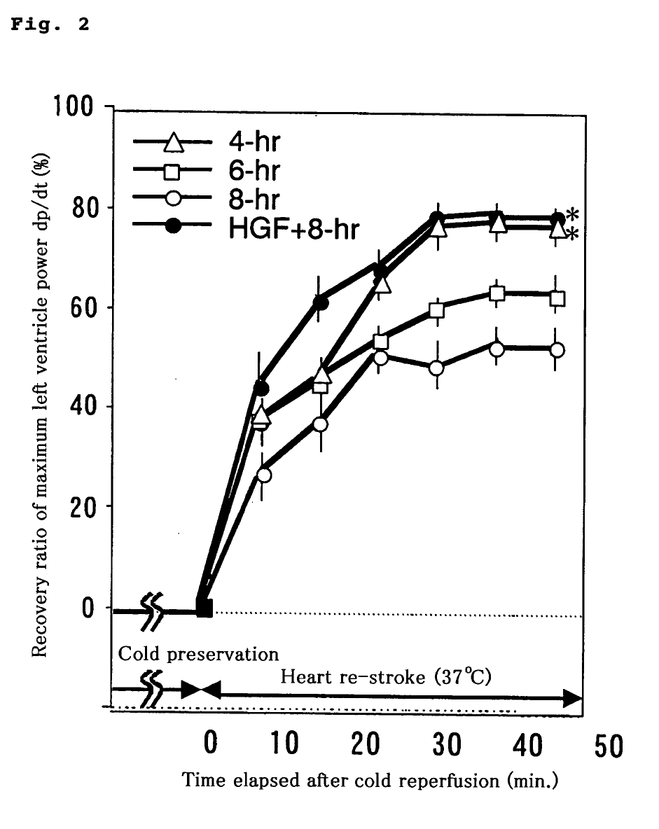

FIG. 2 shows the recovery ratio of the maximum left ventricle power dp/dt. The maximum left ventricle power after four hours and six hours of cold preservation in Euro-Collins solution recovered about 80% and about 60%, respectively, within one hour after the resumption of heart strokes. The maximum left ventricle power after eight hours cold preservation in Euro-Collins solution recovered about 50% one hour after the resumption of heart strokes. Meanwhile, in the case where the hearts were perfused with the organ preservation/perfusion solution of Example 6 and preserved in cold Euro-Collins solution for eight hours, the maximum left ventricle power recovered about 80%, which confirmed significant improvement by HGF.

(3) Activity of an Enzyme (CPK) Deviated from Cardiac Muscles in Coronary Vessels

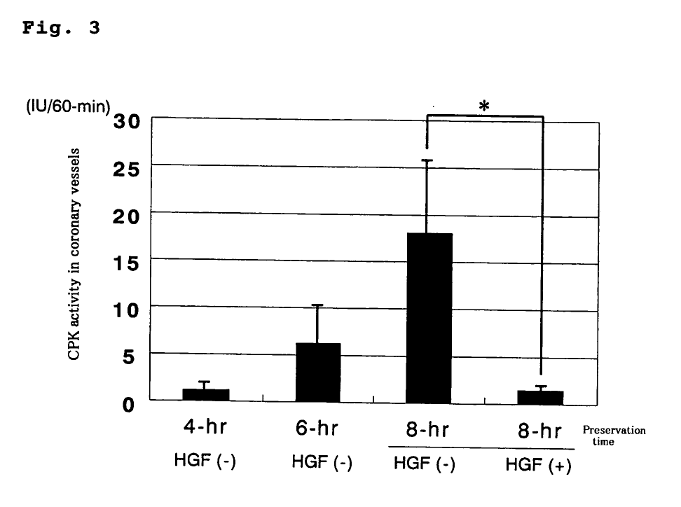

FIG. 3 shows the CPK activity in coronary vessels. The CPK value increased according to the cold preservation time. The hearts perfused and cold-preserved for eight hours using Euro-Collins solution showed a high CPK value of about 20 IU/hr. Meanwhile, the hearts perfused with the organ preservation/perfusion solution of Example 6 and cold-preserved in the Euro-Collin solution for eight hours showed a CPK value of 3 IU/hr, which was almost the same as the CPK value of the hearts cold-preserved in the Euro-Collins solution for four hours.

(4) Histopathological Changes

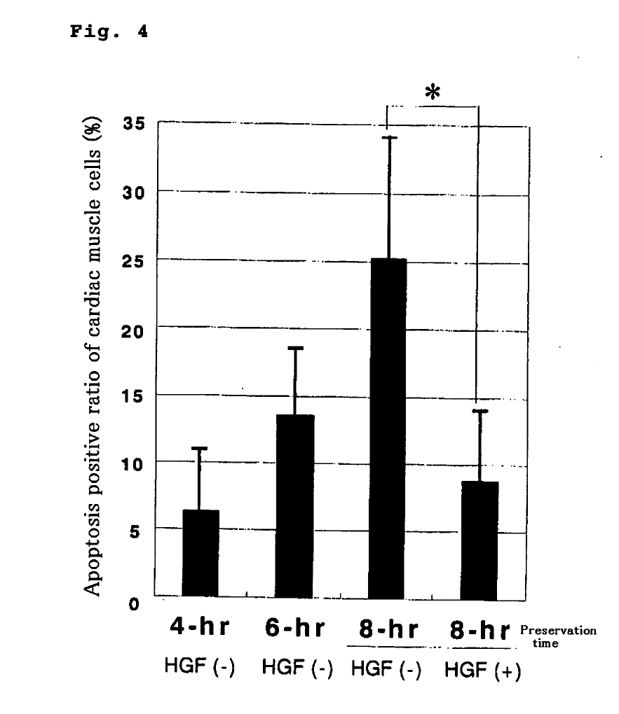

FIG. 4 shows the apoptosis positive ratio of cardiac muscle cells. The apoptosis positive ratio of cardiac muscles increased according to the cold preservation time. The apoptosis positive ratio of cardiac muscles of the hearts preserved in Euro-Collins solution for eight hours was 25%. Meanwhile, the apoptosis positive ratio of cardiac muscles of the hearts perfused with the organ preservation/perfusion solution of Example 6 and cold-preserved in Euro-Collin solution for eight hours was about 9%, which showed a significant decrease of the apoptosis positive ratio.

The above-described results show that the organ preservation/perfusion solution containing HGF suppresses postmortem changes, including apoptosis which progresses during cold-preservation of hearts, and also has the action of improving cardiac functions. The above results also suggest a possibility of extending the time from the excision of hearts to the transplantation thereof.

The method of the present invention is useful for preservation and perfusion of organs for transplantation. The present method can be utilized in the medical transplantation field as a method for long-term cold preservation of harvested organs and also as a method for discharging blood from harvested organs or for washing the harvested organs.

1. a method for preserving a harvested organ, a harvested organ tissue or a part thereof, which comprises bringing various organs, organ tissues or parts thereof from living or dead bodies into contact with a solution containing hepatocyte growth factor (referred to as HGF) having a temperature of 0 to 6° C.:

2. A method for preserving a harvested organ, a harvested organ tissue or a part thereof, which comprises perfusing and/or immersing the harvested organ, harvested organ tissue or part thereof, with a solution containing HGF having a temperature of 0 to 6° C.

3. The method according to claim 1, wherein the solution contains HGF in an amount of 0.1 μg/mL to 1 mg/mL.

4. The method according to claim 1, wherein concentration of HGF for perfusion is 50 μg/mL to 500 μg/mL and concentration of HGF for immersion is 0.1 μg/mL to 50 μg/mL.

5. The method according to claim 1, wherein concentration of HGF for perfusion is 1 μg/mL to 10000 μg/mL and concentration of HGF for immersion is 0.01 μg/mL to 1000 μg/mL.

6. The method according to claim 1, wherein the organ is selected from hearts, livers, kidneys, lungs, pancreases and small intestines, and the organ tissue is selected from skins and corneas.

7. A method for preserving a harvested organ, a harvested organ tissue or a part thereof for a relatively long time up to 10 hours, which comprises perfusing and/or immersing the above-mentioned harvested organ, organ tissue or part thereof, with a solution containing HGF having a temperature of 0 to 6° C.

8. A method for preventing a harvested organ, a harvested tissue or a part thereof from storage injury occurring during the storage of the organs before transplantation or organ failure occurring after transplantation, which comprises perfusing and/or immersing the harvested organ, harvested tissue or part thereof, with a solution containing HGF having a temperature of 0 to 6° C.

9. A solution used for preserving a harvested organ, a harvested organ tissue or a part thereof, comprising HGF of a temperature of 0 to 6° C. in an amount of 0.1 μg/mL to 1 mg/mL.

10. A solution used for perfusing and/or immersing a harvested organ, a harvested organ tissue or a part there, comprising HGF of a temperature of 0 to 6° C. in an amount of 0.1 μg/mL to 1 mg/mL.

11. A solution used for perfusing and/or immersing a harvested organ, a harvested organ tissue or a part there, comprising HGF of a temperature of 0 to 6° C., wherein the concentration of HGF for perfusion is 50 μg/mL to 500 μg/mL and that of HGF for immersion is 0.1 μg/mL to 50 μg/mL.

12. A solution used for perfusing and/or immersing a harvested organ, a harvested organ tissue or a part there, comprising HGF of a temperature of 0 to 6° C., wherein the concentration of HGF for perfusion is 1 μg/mL to 10000 μg/mL and that of HGF for immersion is 0.01 μg/mL to 1000 μg/mL.

13. The solution according to claim 9, wherein the organ is selected from the group consisting of hearts, livers, kidneys, lungs, pancreases, small intestines, skins and corneas.

14. The method according to claim 2, wherein the solution contains HGF in an amount of 0.1 μg/mL to 1 mg/mL.

15. The method according to claim 2, wherein concentration of HGF for perfusion is 50 μg/mL to 500 μg/mL and concentration of HGF for immersion is 0.1 μg/mL to 50 μg/mL.

16. The method according to claim 2, wherein concentration of HGF for perfusion is 1 μg/mL to 10000 μg/mL and concentration of HGF for immersion is 0.01 μg/mL to 1000 μg/mL.

17. The method according to claim 2, wherein the organ is selected from hearts, livers, kidneys, lungs, pancreases and small intestines, and the organ tissue is selected from skins and corneas.

18. The solution according to claim 10, wherein the organ is selected from the group consisting of hearts, livers, kidneys, lungs, pancreases, small intestines, skins and corneas.

19. The solution according to claim 11, wherein the organ is selected from the group consisting of hearts, livers, kidneys, lungs, pancreases, small intestines, skins and corneas.

20. The solution according to claim 12, wherein the organ is selected from the group consisting of hearts, livers, kidneys, lungs, pancreases, small intestines, skins and corneas.
